(19) United States
(12) Patent Application Publication
(10) Pub. No.: US 2011/0156331 A1
(43) Pub. Date: Jun. 30, 2011

(54) NON-CONTACT HOLDER AND NON-CONTACT HOLDING HAND

(75) Inventors: Kenichi HARADA, Chino (JP); Tomonori MORIYA, Chino (JP)

(73) Assignee: SEIKO EPSON CORPORATION, Tokyo (JP)

(21) Appl. No.: 12/974,868

(22) Filed: Dec. 21, 2010

(30) Foreign Application Priority Data
Dec. 28, 2009 (JP) 2009-297054

(51) Int. Cl. B25B 11/00

(52) U.S. Cl. 269/21

(57) ABSTRACT

A non-contact holder holds the workpiece on the holding surface without contact between the workpiece and the holding surface by generating a negative pressure at the opening using a circular flow of gas introduced into the inside of the column body and generating a positive pressure between the holding surface and the workpiece using the gas flowing from the opening provided on the holding surface, and the holding surface has (2n+1) (n: a positive integer) guide grooves which have spiral shapes extending in spiral directions in correspondence with the circulation direction of the circular flow and have starting ends communicating with the opening to guide the gas introduced through the starting ends in the spiral directions, the final ends of the guide grooves being disposed at equal intervals on the circumference of the holding surface around the opening.

### CROSS-REFERENCE TO RELATED APPLICATIONS

This application claims priority to Japanese Patent Application No. 2009-297054 filed on Dec. 28, 2009. The entire disclosure of Japanese Patent Application No. 2009-297054 is hereby incorporated herein by reference.

### BACKGROUND

1. Technical Field

The present invention relates to a non-contact holder and a non-contact holding hand capable of holding a holding target without contact between the holding target and a holding surface of the non-contact holder or the non-contact holding hand by using a negative pressure and a positive pressure acting on different areas of the holding target.

2. Related Art

A non-contact holder which holds a workpiece such as a liquid crystal substrate and a semiconductor wafer without contact between the workpiece and a holding surface of the non-contact holder is known as disclosed in JP-A-2008-87910, for example. A typical non-contact holder which uses a circular flow of gas is constituted by a column body whose one end surface located opposed to a workpiece corresponds to a holding surface. When a circular flow of gas formed within the column body flows from an opening provided on the holding surface toward the space between the workpiece and the holding surface, a negative pressure is produced by the circular flow at the center of the opening provided on the holding surface. Simultaneously, a positive pressure is produced by the gas in an area outside the opening provided on the holding surface. As a result, the workpiece is held on the holding surface without contact between the workpiece and the holding surface by using the negative pressure and the positive pressure acting on the different areas of the workpiece.

According to this structure, the gas flowing from the opening provided on the holding surface forms a spiral track in the direction parallel with the holding surface by the effect of the inertial force and the centrifugal force produced by the circulation. In this case, the gas flowing from the opening contacts the gas flowing along the periphery of the opening, and the gas flowing from the opening contacts the holding surface. Therefore, the spiral track formed by the gas flowing from the opening and also the circulation condition of the circular flow generated within the column greatly vary according to the flow of the gas flowing from the opening, that is, the surface roughness of the holding surface and the flow of the gas on the periphery of the opening.

When the distribution of the surface roughness is greatly unbalanced within the plane of the holding surface, for example, an area producing a relatively large pressure loss is formed within the plane of the holding surface. In this case, the pressure in the area producing the large pressure loss becomes lower than the pressure in other area, which locally forms a lower pressure portion in the positive pressure generated between the holding surface and the workpiece. Moreover, when the flowing speed of the gas flowing from the opening rapidly decreases due to friction with the gas around the opening, for example, the circulation condition of the circular flow generated within the column varies in accordance with the rapid decrease in the flowing speed. In this case, the negative pressure produced by the circular flow also greatly changes.

When the negative pressure acting on the workpiece varies or the positive pressure locally changes as described above, the distance between the workpiece and the holding surface is difficult to remain the same within the plane of the holding surface. In this case, the posture of the workpiece becomes unstable. Moreover, when the workpiece is held by a plurality of non-contact holders, the change of the negative pressure and the local change of the positive pressure are produced in timing different for each non-contact, holder. In this case, the posture of the held workpiece becomes further unstable.

### SUMMARY

An advantage of some aspects of the invention is to provide a non-contact holder and a non-contact holding hand capable of stabilizing the posture of a workpiece to be held.

A non-contact holder according to an aspect of the invention includes: a column body which has an opening formed continuously from a column inner circumferential surface and opened to a holding surface opposed to a workpiece. The non-contact holder holds the workpiece on the holding surface without contact between the workpiece and the holding surface by generating a negative pressure at the opening using a circular flow of gas introduced into the inside of the column body and generating a positive pressure between the holding surface and the workpiece using the gas flowing from the opening provided on the holding surface. The holding surface has (2n+1) (n: a positive integer) guide grooves which have spiral shapes extending in spiral directions in correspondence with the circulation direction of the circular flow and have starting ends communicating with the opening to guide the gas introduced through the starting ends in the spiral directions, the final ends of the guide grooves being disposed at equal intervals on the circumference of the holding surface around, the opening.

According to the non-contact holder of this aspect of the invention, the gas flowing from the opening provided on the holding surface is guided by the “2n+1” guide grooves formed on the holding surface toward the outside of the holding surface. In this case, the gas flowing from the opening and guided by the plural guide grooves toward the outside of the holding surface does not rapidly decrease its flowing speed by friction with gas around the opening or the like. Thus, the circulation condition of the circular flow generated within the column, and further the negative pressure generated by the circular flow can be stabilized. Moreover, since the gas flows out through the “2n+1” guide grooves, the flowing speed of the gas introduced to the guide grooves becomes lower than that of gas flowing out through one guide groove having the same flow path cross-sectional area as each cross-sectional area of the “2n+1” guide grooves. Thus, even when an area producing a relatively large pressure loss is formed within the plane of the holding surface, the pressure loss of the gas flowing through the guide grooves is reduced by the decrease in the flowing speed of the gas within the guide grooves. As a result, a local pressure drop at the time of generation of a positive pressure between the holding surface and the workpiece can be reduced. According to the non-contact holder of this aspect of the invention, therefore, the negative pressure and the positive pressure acting on the workpiece can be stabilized, and thus the posture of the workpiece can be stabilized.

On the other hand, rapid pressure drops are produced at the final ends of the respective guide grooves when the gas having passed through the guide grooves flows to the outside. In case of a structure which includes only one guide groove on the holding surface, the rapid pressure drop in the vicinity of the final end of the guide groove is produced at one point of the holding surface. In this case, there is a possibility that the workpiece is attracted to the final end and inclined thereto, and that the workpiece is shifted by the flow of the gas flowing to the outside. According to the non-contact holder of this aspect of the invention, however, the final ends of the guide grooves are disposed at equal intervals on the circumference around the opening. Thus, the pressure drops around the final ends discussed above are given uniformly around the opening. Accordingly, the posture of the workpiece can be further stabilized.

The non-contact holder is constructed such that the opening provided on the holding surface has a circular shape, and that the starting ends of the guide grooves are disposed at equal intervals in the circumferential direction of the opening.

According to this non-contact holder, the starting ends of the guide grooves are disposed at equal intervals in the circumferential direction of the opening having the circular shape. Thus, the gas introduced into the respective guide grooves becomes more uniform, which further stabilizes the posture of the workpiece.

The non-contact holder is constructed such that each of the guide grooves has an inside wall surface as a wall surface relatively close to the opening, an outside side wall surface relatively far from the opening, and a bottom surface connecting the inside wall surface and the outside wall surface, and that the outside wall surface is a surface extending in parallel with the normal line of the holding surface.

According to this non-contact holder, when the gas collides with the outside wall surface due to the centrifugal force given toward the outside wall surface, a larger amount of the gas comes to flow toward the inside wall surface or the bottom surface. Accordingly, the gas flowing through the guide grooves cannot easily go over the outside wall surface, and thus the gas flowing from the opening can be securely guided along the guide grooves.

The non-contact holder is constructed such that each of the guide grooves has an inside wall surface as a wall surface relatively close to the opening, an outside wall surface relatively far from the opening, and a bottom surface connecting the inside wall surface and the outside wall surface, and that the outside wall surface is an inclined surface inclined toward the opening with respect to the normal line of the holding surface.

According to this non-contact holder, when the gas collides with the outside wall surface due to the centrifugal force given toward the outside wall surface, a larger amount of the gas comes to flow toward the bottom surface. Accordingly, the gas flowing through the guide grooves cannot easily go over the outside wall surface, and thus the gas flowing from the opening can be securely guided along the guide grooves.

The non-contact holder is constructed such that the column body is a cylindrical body which has an introduction path having an opening on the column inner circumferential surface and extending tangentially to the column inner circumferential surface.

According to this non-contact holder, the gas introduced into the column through the introduction path flows tangentially to the inner circumferential surface of the column body. Thus, the circular flow can be efficiently generated within the column body.

It is preferable that the non-contact holder is constructed such that the plural introduction paths are disposed on the column inner circumferential surface at equal intervals in the circumferential direction of the column inner circumferential surface.

According to this non-contact holder, the gas is introduced to a circular flow generating portion through the plural introduction paths disposed at equal intervals. In this structure, the circular flow can be further efficiently generated.

A non-contact holding hand according to another aspect of the invention includes: a holder unit which includes the plural non-contact holders described above; and an arm connecting with the holder unit. The same number of the non-contact holders are provided for each of different circulation directions of the circular flow in such a manner that the holding surfaces of the respective non-contact holders are disposed on the same plane as the plural non-contact holders.

According to the non-contact holding hand of this aspect of the invention, the rotational force of the workpiece generated by the gas flowing along each of the guide grooves is mutually canceled on the non-contact holders held by the holder unit. Accordingly, the rotation of the workpiece in the direction parallel with the holding surface is prevented, and thus the posture of the workpiece can be further securely stabilized.

### BRIEF DESCRIPTION OF THE DRAWINGS

The invention will be described with reference to the accompanying drawings, wherein like numbers reference like elements.

FIG. 1 is a perspective view illustrating a disassembled non-contact holding hand according to an embodiment of the invention.

FIGS. 2A and 2B are perspective views illustrating a perspective structure of a holding unit, wherein: FIG. 2A is a perspective view as viewed from the side opposite to a holding surface; and FIG. 2B is a perspective view as viewed from the holding surface.

FIG. 3A is a plan view of the holding unit as viewed from the holding surface, and FIG. 3B is a cross-sectional view taken along a line A-A.

FIG. 4 is a cross-sectional view illustrating the structure of a guide groove according to a modified example.

FIG. 5 a cross-sectional view illustrating the structure of a guide groove according to another modified example.

FIG. 6 is a plan view illustrating the structure of circular flow generating portions according to a further modified example.

### DESCRIPTION OF EXEMPLARY EMBODIMENT

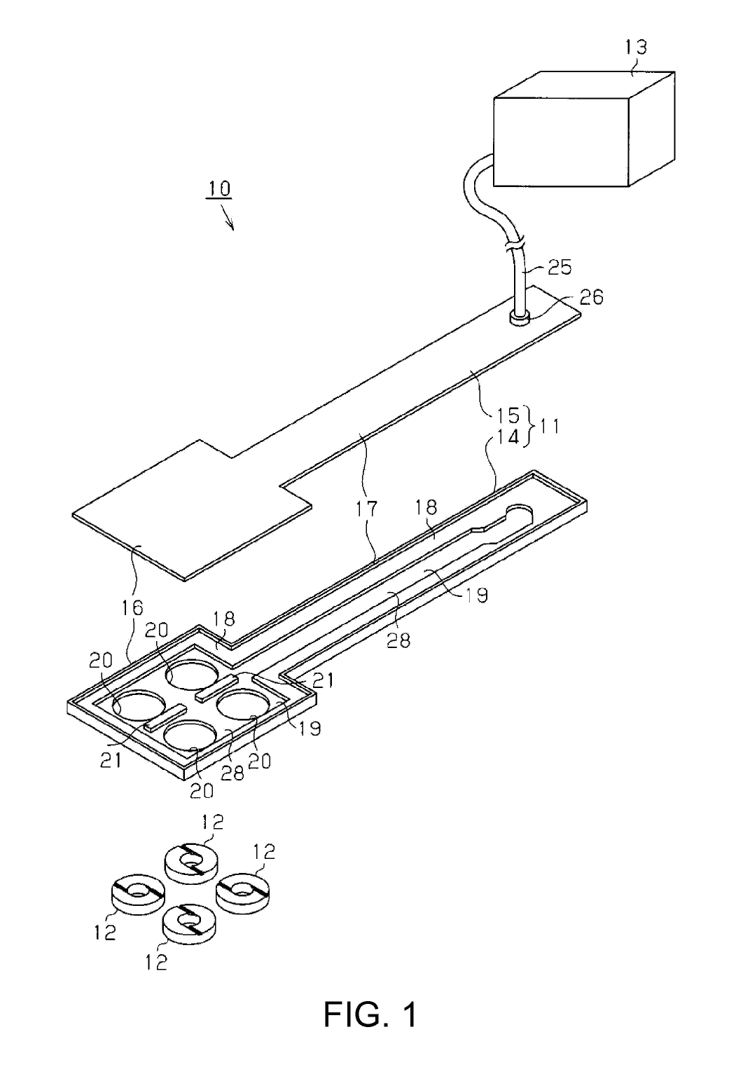

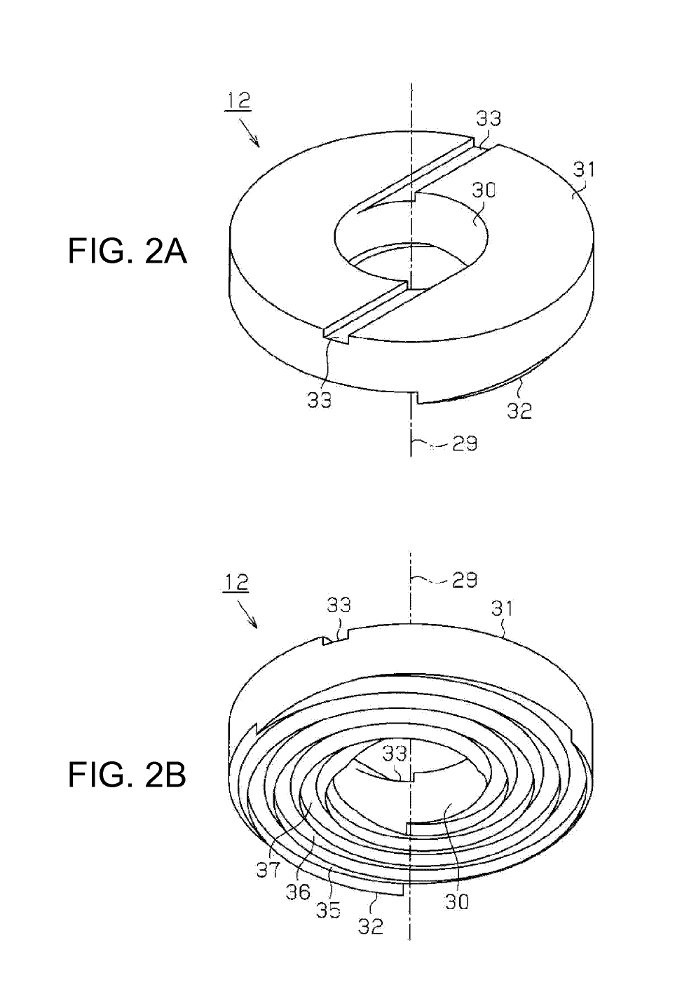

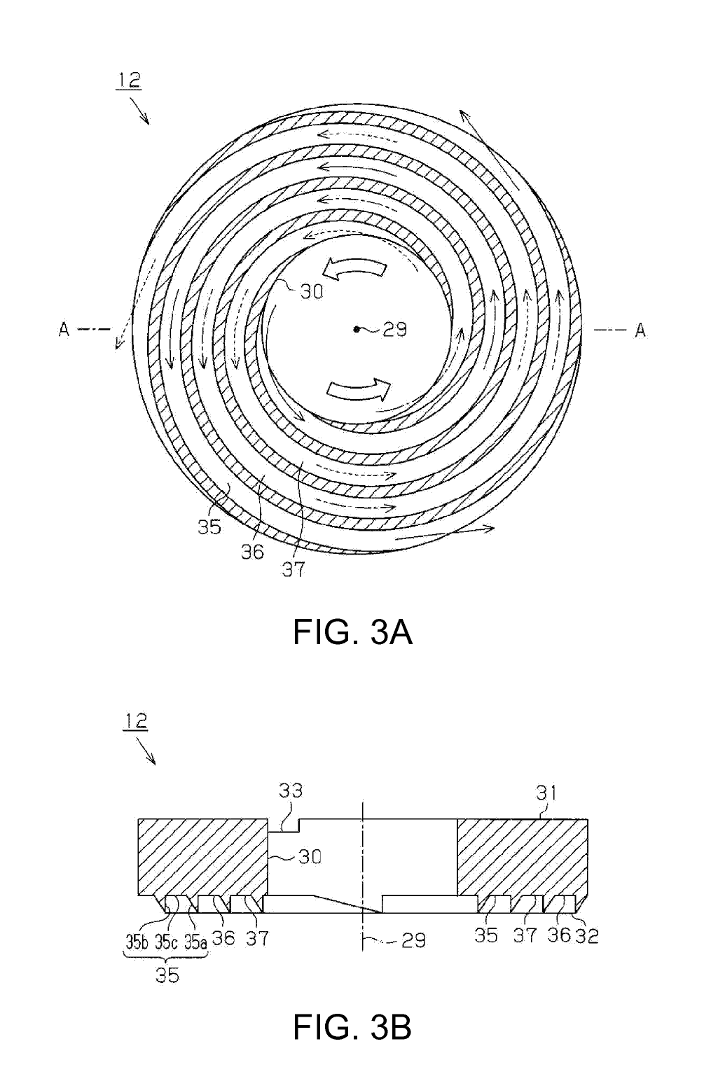

A non-contact holding hand including a non-contact holder according to an embodiment of the invention is hereinafter described with reference to FIGS. 1 through 38. FIG. 1 is a perspective view illustrating a disassembled non-contact holding hand. FIGS. 2A and 2B illustrate the structure of a holding unit, wherein: FIG. 2A is a perspective view of the holding unit as viewed from the side opposite to a holding surface; and FIG. 2B is a perspective view of the holding unit as viewed from the holding surface. FIG. 3A is a plan view of the holding unit as viewed from the holding surface, and FIG. 3B is a cross-sectional view taken along a line A-A in FIG. 3A.

As illustrated in FIG. 1, a non-contact holding hand 10 includes a case unit 11, holding units 12 as column bodies, and a compressed air supply source 13 as a gas supply source.

The case unit 11 is constituted by a lower case 14 and an upper case 15 fixed to the lower case 14. The case unit 11 has a holder portion 16 where the holding units 12 are disposed, and an arm portion 17 linearly extending from the holder portion 16. The arm portion 17 functions as a grip when the non-contact holding hand 10 is held by hand, and as an attachment portion when the non-contact holding hand 10 is attached to a device.

The lower case 14 has a multistep concave portion 19 having a step 18 connecting with the holder portion 16 and the arm portion 17. The holder portion 16 of the lower case 14 has four through holes 20 disposed in matrix as holes opened to the bottom of the concave portion 19 and having circular cross sections. A spacer portion 21 having the same height as that of the step 18 projects from the bottom of the concave portion 19 at a position between each of the two opposed pairs of the through holes 20 in the direction perpendicular to the extending direction of the arm portion 17.

The upper case 15 has a flat plate shape. A tube connection port 26 connected with the compressed air supply source 13 via a tube 25 is formed at one end of the upper case 15. The upper case 15 is inserted into the concave portion 19 in such a condition as to contact the step 18 of the concave portion 19 and the upper surfaces of the spacer portions 21, and airtightly fixed to the lower case 14.

In this arrangement, a compressed air supply path 28 to which compressed air is supplied from the compressed air supply source 13 via the tube connection port 26 is formed by the lower case 14 and the upper case 15 as a space having the same height as the heights of the step 18 and the spacer portions 21.

The holding units 12 are inserted into the four through holes 20. As illustrated in FIG. 2A, the holding unit 12 has a cylindrical shape whose center axis corresponds to an axis 29 and is shaped in such a manner that the outer circumferential surface of the holding unit 12 contacts the surface of the through hole 20. In this arrangement, the inner circumferential surface of the column body forms a cylindrical inner space. The holding unit 12 has an end surface 31 which contacts the lower surface (contact surface) of the uppercase 15, and a holding surface 32 disposed at a position slightly projected from the lower surface of the lower case 14. The holding surfaces 32 of the respective holding units 12 are located on the same plane crossing the axis 29 at right angles. The holding unit 12 is bonded and fixed to the upper case 15 in such a manner that the top surface of the inner space of the holding unit 12 is closed by the contact surface of the upper case 15 as the closing member, and is airtightly bonded and fixed to the through hole 20 of the lower case 14. The closure of the inner space by the upper case 15 produces a circular flow generating portion 30. That is, the holding unit 12 and the upper case 15 constitute the non-contact holder.

A pair of introduction paths 33 through which compressed air within the compressed air supply path 28 is introduced into the circular flow generating portion 30 are concaved on the end surface 31 of each of the holding units 12. Each of the introduction paths 33 has one end on the inner circumferential surface of the circular flow generating portion 30, and the other end on the outer circumferential surface of the holding unit 12, and each opened portion of the introduction paths 33 on the end surface 31 is closed by the upper case 15. The pair of the introduction paths 33 extend tangentially to the cross-sectional circle of the circular flow generating portion 30 in directions opposite to each other from the opposed positions on the inner circumferential surface of the circular flow generating portion 30. Thus, the one ends of the pair of the introduction paths 33 are provided at equal intervals on the inner circumferential surface of the circular flow generating portion 30. According to this structure, the compressed air introduced into the circular flow generating portion 30 via the introduction paths 33 flows in the tangential directions and thus causes a flow along the inner circumferential surface of the circular flow generating portion 30. As a result, a circular flow around the axis 29 can be efficiently produced within the circular flow generating portion 30. Moreover, since the compressed air is introduced into the circular flow generating portion 30 from a plurality of opposed positions, the circular flow can be more efficiently produced within the circular flow generating portion 30. The circulation of the compressed air thus produced within the circular flow generating portion 30 generates a negative pressure at the center of the circular flow generating portion 30 based on Bernoulli's theorem to attract the workpiece to the holding surface 32. The compressed air circulated within the circular flow generating portion 30 flows from the opening on the holding surface 32 to the outside along the holding surface 32.

The holding surface 32 of the holding unit 12 is now explained in more detail. The two holding units 12 having the opposite circulation directions have the same basic structure except for the opposite circulation directions. Thus, the holding surface 32 of the holding unit 12 having one of the circulation directions is only discussed, and the detailed explanation of the holding surface 32 of the holding unit 12 having the other circulation direction is not repeated.

As illustrated in FIG. 2B, the holding surface 32 of the holding unit 12 has an odd number of (three in this embodiment) guide grooves 35, 36, and 37 extending in spiral shapes from the opening of the circular flow generating portion 30 on the holding surface 32. As illustrated in FIG. 3A, the guide grooves 35, 36, and 37 are formed in directions corresponding to the circulation direction of the circular flow generated in the circular flow generating portion 30. The guide grooves 35, 36, and 37 have the same structures rotated from each other by 120 degrees around the axis 29. That is, the respective starting ends of the guide grooves 35, 36, and 37 are disposed at equal intervals in the circumferential direction of the opening. The compressed air flowing from the circular flow generating portion 30 is guided by each of the guide grooves 35, 36, and 37, and then flows out of the holding surface 32. In this case, the compressed air introduced to the guide grooves 35, 36, and 37 uniformly flows thereinto due to the equal intervals of the starting ends of the guide grooves 35, 36, and 37 in the circumferential direction of the opening. In FIG. 3A, the flow of the compressed air along the guide groove 35 is indicated by solid lines, the flow of the compressed air along the guide groove 36 is indicated by alternate long and two short dashes lines, and the flow of the compressed air along the guide groove 37 is indicated by dotted lines.

As illustrated in FIG. 3B, the guide groove 35 has an inside wall surface 35a as a wall surface close to the axis 29 of the circular flow generating portion 30 on the flow path cross section containing the axis 29 of the circular flow generating portion 30, an outside wall surface 35b as a wall surface located away from the axis 29, and a bottom surface 35c as a wall surface connecting the inside wall surface 35a and the outside wall surface 35b. The inside wall surface 35a is constituted by an inclined surface inclined to the axis 29 of the circular flow generating portion 30 such that the flow path cross section of the inside wall surface 35a expands on the holding surface 32 side. The outside wall surface 35b is constituted by a vertical surface extending in parallel with the axis 29 of the circular flow generating portion 30. The inside wall surfaces, the outside wall surfaces, and the bottom surfaces of the guide grooves 36 and 37 are similarly constructed. According to the guide-grooves 35, 36, and 37 having this structure, the centrifugal force of the compressed air produced by the circular flow is received by the outside wall surfaces as the vertical wall surfaces. Thus, the compressed air cannot easily go over the outside wall surfaces but can be securely guided along the guide grooves 35, 36, and 37. Moreover, since the inside wall surface 35a is an inclined surface, the physical strength of the wall portion constituting the guide groove 35 increases. In this arrangement, a part of the compressed air flowing along the guide grooves 35, 36, and 37 flows out through the opened portions of the guide grooves 35, 36, and 37 toward the holding surface 32. Then, the compressed air having flowed out generates a positive pressure between the holding surface 32 and the workpiece. According to the non-contact holding hand 10, the workpiece is held by the holding surfaces 32 without contact between the workpiece and the holding surfaces 32 by using the positive pressure and the negative pressure described above acting on the workpiece.

The compressed air flowing along the respective guide grooves 35, 36, and 37 in spiral shapes gives a rotational force to the workpiece. Thus, when the four holding units 12 disposed in matrix are all constructed to have the same circulation direction, there is a possibility that the rotational force produced by the compressed air rotates the workpiece. According to the four holding units 12 disposed in matrix in this embodiment, however, each pair of the holding units 12 diagonally located have the same circulation direction of the circular flow, and each pair of the holding units 12 located opposed to each other with the spacer portion 21 interposed therebetween have the opposite circulation directions of the circular flow. In this structure, the rotational force received by each compressed air flowing along the respective guide grooves can be mutually cancelled. Accordingly, the rotation of the workpiece can be prevented, and thus the posture of the workpiece can be stabilized.

In case of the compressed air guided by each of the guide grooves 35, 36, and 37, the turbulence produced by friction with peripheral compressed air becomes smaller than that of compressed air flowing to the outside via a holding surface having no guide groove. Thus, the compressed air guided by the guide grooves 35, 36, and 37 can smoothly flow out of the holding surface 32. In this case, the flowing speed of the compressed air flowing along the guide grooves 35, 36, and 37 does not rapidly decrease with ease, which stabilizes the circulation condition of the circular flow. Accordingly, the change of the negative pressure generated by the circular flow generating portion 30 can be reduced, and thus the posture of the workpiece can be stabilized.

The compressed air as compressive fluid increases its volume when a pressure loss is produced. Thus, the flowing speed of the compressed air within the guide grooves increases when a pressure loss is produced. This increase in the flowing speed easily causes a further pressure loss in the compressed air. That is, the pressure of the compressed air within the guide grooves easily varies.

Concerning this problem, the compressed air is discharged through the three guide grooves 35, 36, and 37 in this embodiment such that the flowing speed of the compressed air immediately after entrance into the guide grooves becomes lower than that speed in a structure which discharges the compressed air through one guide groove having the same flow path cross-sectional area as each cross-sectional area of the guide grooves 35, 36, and 37, for example. Thus, even when pressure loss areas are formed on the guide grooves 35, 36, and 37, the pressure loss of the compressed air flowing along the guide grooves 35, 36, and 37 can be reduced by the decrease in the flowing speed. In addition, since the flowing speed of the compressed air flowing through the guide grooves 35, 36, and 37 decreases, the flowing speed of the compressed air flowing from the opened portions of the guide grooves 35, 36, and 37 and generating the positive pressure decreases accordingly. Thus, even when a pressure loss area is formed on the holding surface 32, the pressure loss on the pressure loss area can be reduced by the decrease in the flowing speed. That is, the guide grooves 35, 36, and 37 provided on the holding surface 32 reduce the pressure losses of both the compressed air flowing along the guide grooves 35, 36, and 37 and the compressed air flowing from the opened portions of the guide grooves 35, 36, and 37 and generating the positive pressure. In other words, both the pressures of the compressed air flowing through the guide grooves 35, 36, and 37 before generation of the positive pressure and the compressed air flowing from the opened portions of the guide grooves 35, 36, and 37 and generating the positive pressure can be stabilized. As a result, the positive pressure toes not locally drop with ease, which stabilizes the posture of the workpiece.

Even in case of the structure which includes only one guide groove, the flowing speed of the compressed air immediately after flowing into the guide groove can be reduced by increasing the flow path cross-sectional area of the guide groove. For allowing the negative pressure generated in the circular flow generating portion 30 to efficiently act on the workpiece, however, it is preferable that the guide groove has a smaller depth. That is, when increasing the flow path cross-sectional area of the guide groove, it is preferable that the bottom surface of the guide groove is enlarged. However, when the bottom surface of the guide groove is enlarged, the flow of the compressed air becomes closer to the flow of compressed air flowing on a holding surface having no guide groove. Thus, rapid decrease in the flowing speed of the compressed air flowing along the guide groove having the enlarged bottom surface is easily produced due to friction or the like, and the change of the negative pressure discussed above is easily caused. According to the structure in this embodiment, however, the flowing speed of the compressed air flowing along the guide grooves 35, 36, and 37 is decreased by using the plural guide grooves 35, 36, and 37 such that the rapid decrease in the flowing speed due to friction or the like can be more reduced than in the structure which includes the guide groove whose bottom surface is enlarged for obtaining the larger flow path cross-sectional area.

In addition, a rapid pressure drop is produced in the vicinity of the final ends of the guide grooves by the discharge of the compressed air out of the holding surface 32. Thus, in case of the structure which includes only one guide groove, for example, this rapid pressure drop around the final end is produced only at one point. In this case, there is a possibility that the workpiece is attracted to the area of the pressure drop and inclined thereto. According to this embodiment, however, the three guide grooves 35, 36, and 37 have the same structures rotated from each other by 120 degrees around the axis 29 of the circular flow generating portion 30. That is, the final ends of the three guide grooves 35, 36, and 37 are disposed at equal intervals on the circumference of the circular flow generating portion 30 around the axis 29. In this structure, the pressure drops at the final ends of the respective guide grooves 5, 36, and 37 are given to the workpiece uniformly around the axis 29. Thus, the inclination of the workpiece caused by the pressure drop around the final end of the guide groove discussed above can be reduced, which further stabilizes the posture of the workpiece.

Therefore, the non-contact holding hand 10 in this embodiment can offer the following advantages.

(1) The holding surface 32 in this embodiment has the guide grooves 35, 36, and 37 which guide the compressed air flowing from the circular flow generating portion 30 toward the outside of the holding surface 32. According to this structure, the turbulence of the flow of the compressed air flowing within the guide grooves 35, 36, and 37 as a result of friction with peripheral compressed air or the like is reduced, allowing the compressed air to smoothly flow to the outside of the holding surface 32. In this case, the flowing speed of the compressed air flowing from the circular flow generating portion 30 does not rapidly decrease with ease, which stabilizes the circulation condition of the circular flow. Accordingly, the change of the negative pressure generated in the circular flow generating portion 30 is reduced, and thus the posture of the workpiece can be stabilized.

(2) The flowing speed of the compressed air flowing along the guide grooves 35, 36, and 37 can be decreased by providing the three guide grooves 35, 36, and 37 on the holding surface 32. Thus, even when pressure loss areas are formed on the guide grooves 35, 36, and 37, the pressure losses produced on the pressure loss areas on the guide grooves 35, 36, and 37 can be reduced by the decrease in the flowing speed of the compressed air.

(3) Moreover, the flowing speed of the compressed air flowing from the opened portions of the guide grooves 35, 36, and 37 and generating the positive pressure can also be decreased. Thus, even when a pressure loss area is formed on the holding surface 32, the pressure loss on the pressure loss area of the holding surface 32 can be reduced by the decrease in the flowing speed of the compressed air.

(4) By the advantages (2) and (3), the pressure of the compressed air flowing from the circular flow generating portion 30 can be stabilized. Thus, the positive pressure does not locally drop with ease, which stabilizes the posture of the workpiece.

(5) According to this embodiment, the starting ends of the guide grooves 35, 36, and 37 are disposed at equal intervals on the opening of the circular flow generating portion 30, and the compressed air is uniformly introduced to the guide grooves 35, 36, and 37. Also, the final ends of the guide grooves 35, 36, and 37 are disposed at equal intervals on the circumference of the circular flow generating portion 30 around the axis 29. In this structure, the rapid pressure drops in the vicinity of the final ends of the guide grooves 35, 36, and 37 are given to the workpiece uniformly around the axis 29. Thus, the inclination of the workpiece caused by the rapid pressure drops around the exits of the guide grooves can be reduced, which further stabilizes the posture of the workpiece.

(6) According to this embodiment, the outside wall surface 35b constituting the guide groove 35 is constituted by a vertical surface extending in parallel with the axis 29 of the circular flow generating portion 30. In this structure, the centrifugal force of the compressed air produced by the circular flow is received by the outside wall surface 35b, and thus the compressed air cannot easily go over the outside wall surface 35b. Accordingly, the compressed air can be securely guided along the guide groove 35.

(7) According to this embodiment, the inside wall surface 35a constituting the guide groove 35 is constituted by an inclined surface inclined to the axis 29 of the circular flow generating portion 30 such that the flow path cross section of the inside wall surface 35a can be expanded on the holding surface 32 side. In this structure, the physical strength of the wall portion sectioning the guide groove 35 can be raised.

(8) According to this embodiment, a pair of the introduction paths 33 extend tangentially to the cross-sectional circle of the circular flow generating portion 30 in the directions opposite to each other from the opposed positions on the inner circumferential surface of the circular flow generating portion 30. In this structure, the compressed air flowing into the circular flow generating portion 30 flows in the tangential directions, which produces a flow along the inner circumferential surface of the circular flow generating portion 30. Thus, the circular flow can be efficiently generated within the circular flow generating portion 30.

(9) The compressed air is introduced into the circular flow generating portion 30 from a plurality of positions opposed to each other. Thus, the circular flow can be further efficiently produced in the circular flow generating portion 30.

(10) According to the non-contact holding hand 10 in this embodiment, the same number of the holding units 12 are provided for each of the different circulation directions as the plural holding units 12. In this structure, the rotational force given to the workpiece by each compressed air flowing along the guide grooves 35, 36, and 37 can be mutually cancelled.

(11) According to the non-contact holding hand 10 in this embodiment, the compressed air existing within the gas supply path is introduced to the circular flow generating portion 30 of each of the holding units 12. That is, the compressed air is introduced to the circular flow generating portion 30 of each of the holding units 12 from the common gas supply path. In this case, the compressed air can be uniformly supplied to the circular flow generating portions 30, which equalizes the negative pressures generated in the respective circular flow generating portions 30.

The embodiment described herein may be modified in the following manners.

According to this embodiment, the compressed air is introduced into the circular flow generating portions 30 of the respective holding units 12 through the compressed air supply path 28. That is, the compressed air is supplied to the respective circular flow generating portions 30 through the common compressed air supply path 28. However, the compressed air may be individually introduced to the circular flow generating portions 30 in such a manner that the negative pressures on the respective holding units 12 can be equalized. In this structure, advantages similar to the advantages (1) through (10) can be provided.

According to this embodiment, the same number of the holding units 12 are provided for each of the different circulation directions as the plural holding units 12. However, when the rotational force given to the workpiece by the compressed air flowing along the guide grooves 35, 36, and 37 has no effect, the plural holding units 12 may be constituted by only the holding units 12 having the same circulation direction, for example. In this structure, advantages similar to the advantages (1) through (9) and (11) can be provided.

According to this embodiment, each of the circular flow generating portion 30 is constituted by the holding unit 12 and the upper case 15. However, the circular flow generating portion may be formed by a concave portion opened to the holding surface 32 of the holding unit 12. In this case, each of the introduction paths 33 is a through hole opened to the holding unit 12 and the circular flow generating portion 30. In this structure, advantages similar to the advantages (1) through (11) can be provided.

According to this embodiment, the holding units 12 as column bodies are constituted by cylindrical bodies. However, the shapes of the column bodies are not limited to cylindrical shapes.

According to this embodiment, the introduction paths 33 are opened to the inner circumferential surface of the circular flow generating portion 30 at equal intervals, and extend tangentially to the cross-sectional circle. However, the introduction paths 33 may have other structures as long as the circular flow can be generated within the circular flow generating portion 30. Furthermore, the opening positions of the introduction paths 33 on the inner circumferential surface of the circular flow generating portion 30 and the extending directions of the introduction paths 33 are not limited to those described in this embodiment. In case of the structure having the modified introduction paths 33, advantages similar to the advantages (1) through (7), (10), and (11) can be provided.

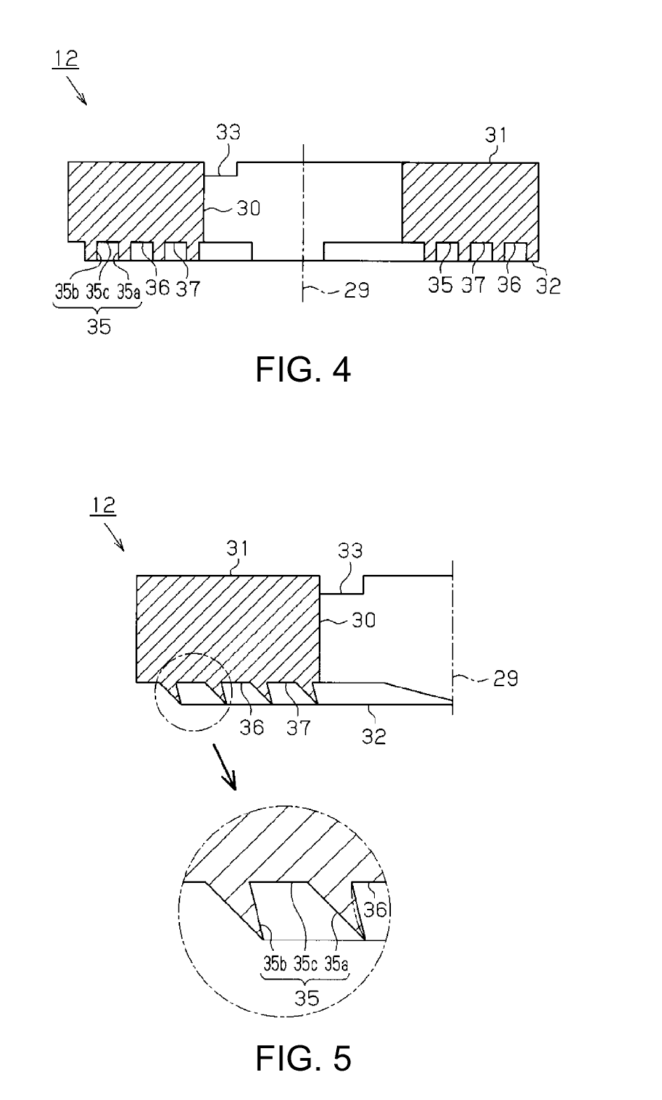

According to the guide groove 35 in this embodiment, the inside wall surface 35a is constituted by an inclined surface inclined to the axis 29 of the circular flow generating portion 30 such that the flow path cross section can be expanded on the holding surface 32 side, and the outside wall surface 35b is constituted by a vertical surface extending in parallel with the axis 29 of the circular flow generating portion 30. However, the guide groove 35 is not limited to this example constructed as above. For example, as illustrated in FIG. 4, both of the inside wall surface 35a and the outside wall surface 35b may be constituted by vertical surfaces extending in parallel with the axis 29 of the circular flow generating portion 30. In this structure, advantages similar to the advantages (1) through (11) can be provided, and also the guide groove 35 can be easily produced. Moreover, the mechanical strength of the wall portions sectioning the adjoining guide grooves can be further raised.

For example, the outside wall surface 35b may be constituted by an overhang surface as an inclined surface inclined to the axis 29 of the circular flow generating portion 30 in such a manner as to overhang the bottom surface 35c as indicated by solid lines in FIG. 5. Alternatively, as indicated by an imaginary line in FIG. 5, the outside wall surface 35b may be constituted by an overhang wall surface as a wall surface curved toward the axis 29 of the circular flow generating portion 30 in such a manner as to overhang the bottom surface 35c. In these structures, advantages similar to the advantages (1) through (11) can be provided, and also the layered flow condition of the compressed air flowing along the guide grooves can be maintained for a longer period.

According to this embodiment, the three guide grooves 35, 36, and 37 are formed on the holding surface 32. However, the guide grooves provided on the holding surface 32 are not limited to these grooves 35, 36, and 37 as long as three or a larger odd number of the guide grooves are formed in such a manner that the final ends of the guide grooves are disposed at equal intervals on the circumference around the axis 29 of the circular flow generating portion 30. For example, five guide groves may be formed on the holding surface. In this structure, advantages similar to the advantages (1) through (11) can be provided.

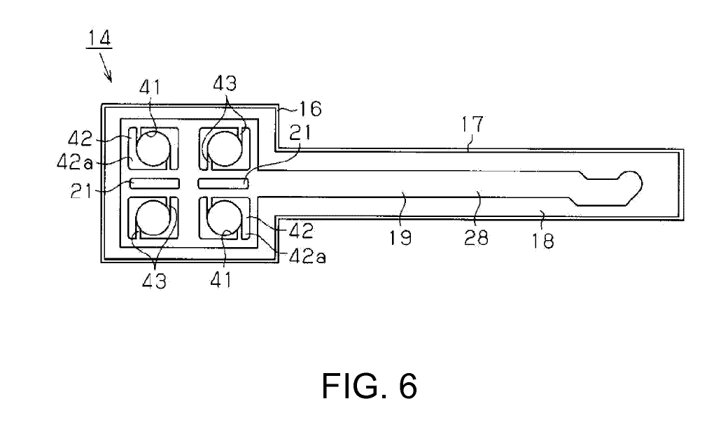

According to this embodiment, the circular flow generating portion is formed by the holding unit 12 and the upper case 15. However, the circular flow generating portion may be constituted by the lower case 14, the upper case 15, and the holding unit 12 as illustrated in FIG. 6, for example. In FIG. 6, similar reference numbers are given to parts similar to those in the embodiment.

More specifically, as illustrated in FIG. 6, the holder portion 16 of the lower case 14 includes through holes 41 each of which constitutes the circular flow generating portion. Each of the through holes 41 is a hole penetrating a convex portion 42 which projects from the bottom surface of the concave portion 19 to the same height as that of the spacer portion 21. The convex portion 42 has a pair of introduction paths 43 concaved on an end surface 42a in contact with the upper case 15 and extending tangentially to the cross-sectional circle of the through hole 41 in opposite directions from the inner circumferential surface of the through hole 41. In this structure, the compressed air within the compressed air supply path 28 can be introduced into the through hole 41 via the pair of the introduction paths 43. The holding unit has the guide, grooves 35, 36, and 37 on the holding surface 32, and has a cylindrical shape which includes a through hole having the same cross-sectional circle as that of the through hole 41 of the lower case 14. The lower case 14 and the holding unit thus constructed are bonded and fixed to each other such that the center axes of the through hole 41 of the lower case 14 and the through hole of the holding unit 12 agree with each other. By using these through holes thus formed, the circular flow generating portion may be produced. In this structure, advantages similar to the advantages (1) through (11) c/an be provided.

While compressed air is used as gas according to the non-contact holding hand 10 in this embodiment, inert gas may be employed as gas, for example.

What is claimed is:

1. A non-contact holder comprising:
a column body which has an opening formed continuously from a column inner circumferential surface and opened to a holding surface opposed to a workpiece,
wherein the non-contact holder holds the workpiece on the holding surface without contact between the workpiece and the holding surface by generating a negative pressure at the opening using a circular flow of gas introduced into the inside of the column body and generating a positive pressure between the holding surface and the workpiece using the gas flowing from the opening provided on the holding surface, and
the holding surface has (2n+1) (n: a positive integer) guide grooves which have spiral shapes extending in spiral directions in correspondence with the circulation direction of the circular flow and have starting ends communicating with the opening to guide the gas introduced through the starting ends in the spiral directions, the final ends of the guide grooves being disposed at equal intervals on the circumference of the holding surface around the opening.

2. The non-contact holder according to claim 1, wherein
the opening provided on the holding surface has a circular shape; and
the starting ends of the guide grooves are disposed at equal intervals in the circumferential direction of the opening.

3. The non-contact holder according to claim 1, wherein
each of the guide grooves has an inside wall surface as a wall surface relatively close to the opening, an outside side wall surface relatively far from the opening, and a bottom surface connecting the inside wall surface and the outside wall surface; and
the outside wall surface is a surface extending in parallel with the normal line of the holding surface.

4. The non-contact holder according to claim 1, wherein
each of the guide grooves has an inside wall surface as a wall surface relatively close to the opening, an outside side wall surface relatively far from the opening, and a bottom surface connecting the inside wall surface and the outside wall surface; and
the outside wall surface is an inclined surface inclined toward the opening with respect to the normal line of the holding surface.

5. The non-contact holder according to claim 1, wherein the column body is a cylindrical body which has an introduction path having an opening on the column inner circumferential surface and extending tangentially to the column inner circumferential surface.

6. The non-contact holder according to claim 5, wherein the plural introduction paths are disposed on the column inner circumferential surface at equal intervals in the circumferential direction of the column inner circumferential surface.

7. A non-contact holding hand, comprising:
a holder unit which includes the plural non-contact holders according to claim 1; and
an arm connecting with the holder unit,
wherein the same number of the non-contact holders are provided for each of different circulation directions of the circular flow in such a manner that the holding surfaces of the respective non-contact holders are disposed on the same plane as the plural non-contact holders.
